(19) United States
(12) Patent Application Publication
(10) Pub. No.: US 2022/0342126 A1
(43) Pub. Date: Oct. 27, 2022

(54) OPTICAL FILMS AND METHODS OF MANUFACTURING SUCH OPTICAL FILMS

(71) Applicant: 3M INNOVATIVE PROPERTIES COMPANY, St. Paul, MN (US)

(72) Inventors: Daniel M. Lentz, Cottage Grove, MN (US); Kevin W. Gotrik, Hudson, WI (US); Jeremy K. Larsen, Farmington, MN (US); Caleb T. Nelson, McKinney, TX (US); Daniel J. Schmidt, Woodbury, MN (US); Fei Peng, Southbury, CT (US)

(21) Appl. No.: 17/753,281

(22) PCT Filed: Aug. 28, 2020
(86) PCT No.: PCT/IB2020/058076

§ 371 Date: Feb. 25, 2022

Related U.S. Application Data
(60) Provisional application No. 62/895,326, filed on Sep. 3, 2019.

(51) Int. Cl. G02B 5/00; B29D 11/00; C23C 18/31; C23C 18/20; C23C 18/16

(52) U.S. Cl. CPC G02B 5/003; B29D 11/00788; B29D 11/00865; C23C 18/31; C23C 18/20; C23C 18/1689

(57) ABSTRACT

A method of manufacturing an optical film includes providing a base film. The base film includes a substrate defining a first surface and a second surface. The base film also includes a plurality of structures defining an upper surface and at least one side surface extending from the corresponding upper surface to a base portion. The method also includes depositing a catalyst material on each of the plurality of structures and the base portion to form a catalyst layer thereon. The method further includes selectively removing the catalyst layer from the upper surface of each of the plurality of structures and the base portion while retaining an activity of the catalyst layer on the at least one side surface of each of the plurality of structures. The method includes forming a metallic layer on the at least one side surface of each of the plurality of structures.

### TECHNICAL FIELD

The present disclosure relates to optical films, and more specifically to optical films for use in various optical applications and methods of manufacturing such optical films.

### BACKGROUND

Optical films, such as Light Control Films (LCF), are configured to regulate a directionality of transmitted light. Various optical films are known, and typically include a light transmissive film having a plurality of channels that are formed of a light absorbing material. Optical films can be placed proximate to a display surface, image surface, or other surface to be viewed. Typically, images being displayed can be viewed through the optical film only when a viewer is positioned within a range of angles referred to as a “viewing angle”. Normally, the viewing angle is a range of angles centered on an axis normal to a surface or a plane of the optical film. As a position of the viewer changes such that the viewer is positioned outside the viewing angle, images being displayed are less or no longer viewable. This can provide privacy to the viewer by blocking observation by others that are outside a typical range of viewing angles.

Optical film can also be used in automotive display applications. Currently, automotive electrification includes increased use of displays in automobiles where back reflection off of a windshield of the automobiles is undesired. The use of optical films in car displays is a way to collimate output from the display to avoid light travelling upwards and backwards to the windshield, and then to a driver's eye. However, traditional optical films that are used for privacy and light collimation applications suffer from undesired absorption of light passing through the film on-axis, which is unavoidable due to the geometries of the channels. Optical films that include carbon black-filled micro-replicated channels are at least 7-8 micron meters (μm) wide and cause an overall loss of on-axis light transmission in an application. It would be desirable to have an optical film with high transmission capability that has necessary functionalities and thickness for use in various applications.

### SUMMARY

Generally, the present invention relates to optical films. The present invention also relates to optical films for use with optical applications and methods of manufacturing such optical films.

In one embodiment of the present disclosure, a method of manufacturing an optical film is provided. The method includes providing a base film. The base film includes a substrate defining a first surface and a second surface disposed opposite to the first surface. The base film also includes a plurality of structures extending from a base portion. Each of the plurality of structures defines an upper surface and at least one side surface extending from the corresponding upper surface to the base portion. The method also includes depositing a catalyst material on each of the plurality of structures and the base portion to form a catalyst layer thereon. The method further includes selectively removing the catalyst layer from the upper surface of each of the plurality of structures and the base portion while retaining an activity of the catalyst layer on the at least one side surface of each of the plurality of structures. The method further includes forming a metallic layer on the at least one side surface of each of the plurality of structures. The metallic layer is generated by electroless metal growth due to a reaction between the catalyst layer and one or more reagents.

In some embodiments, the optical film includes a plurality of channels formed between adjacent structures of the plurality of structures.

In some embodiments, each of the plurality of channels is filled with a material similar to a material of the structures.

In some embodiments, a cross-section of each of the plurality of structures includes at least one of a square shape, a circular shape, a trapezoidal shape, and a polygonal shape.

In some embodiments, the catalyst material includes at least one of nickel, copper, cobalt, silver, gold, iridium, ruthenium, platinum, and palladium.

In some embodiments, the method includes darkening the metallic layer.

In some embodiments, the method includes providing an absorption layer on the metallic layer by micro-etching.

In some embodiments, the base film is formed by micro-replication.

In some embodiments, the catalyst layer is selectively removed by a reactive-ion etching process or a sputter etching process.

In some embodiments, the method further includes providing a liner on the second surface of the substrate.

In some embodiments, the method includes removing the liner from the second surface after the formation of the metallic layer.

In another embodiment of the present disclosure, a method of manufacturing an optical film is provided. The method includes providing a base film. The base film includes a substrate defining a first surface and a second surface disposed opposite to the first surface. The base film also includes a plurality of structures extending from a base portion, wherein each of the plurality of structures defines an upper surface and at least one side surface extending from the corresponding upper surface to the base portion. The method also includes depositing a catalyst layer on each of the plurality of structures and the base portion. The method further includes selectively passivating the catalyst layer on the upper surface of each of the plurality of structures and the base portion while retaining an activity of the catalyst layer on the at least one side surface of each of the plurality of structures. The method includes forming a metallic layer on the at least one side surface of each of the plurality of structures, wherein the metallic layer is generated by electroless metal growth due to a reaction between the catalyst layer and one or more reagents.

In another embodiment of the present disclosure, an optical film is provided. The optical film includes a base film. The base film includes a substrate defining a first surface and a second surface disposed opposite to the first surface. The base film also includes a plurality of structures extending from a base portion, wherein each of the plurality of structures defines an upper surface and at least one side surface extending from the corresponding upper surface to the base portion. The optical film also includes a discontinuous first metallic layer disposed on the at least one side surface of the plurality of structures. The optical film further includes a second metallic layer disposed on the first metallic layer on the at least one side surface of each of the plurality of structures.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the figures refer to like components. When pluralities of similar elements are present, a single reference numeral may be assigned to each plurality of similar elements with a small letter designation referring to specific elements. When referring to the elements collectively or to a non-specific one or more of the elements, the small letter designation may be eliminated. However, it will be understood that the use of a numeral to refer to a component in a given figure is not intended to limit the component in another figure labeled with the same number.

FIG. 1 is a perspective view of an optical film according to an embodiment of the present disclosure;

FIG. 2 is a side view of a base film of the optical film of FIG. 1;

FIG. 3 is a side view illustrating a catalyst layer provided on the base film of FIG. 2;

FIG. 4 is a side view illustrating a discontinuous catalyst layer formed on the base film of FIG. 2;

FIG. 5 is a side view illustrating a metallic layer formed on the discontinuous catalyst layer of FIG. 4;

FIG. 6 is a side view illustrating an absorption layer formed on the metallic layer of FIG. 5;

FIG. 6A is a side view illustrating the optical film with material filled in channels of the optical film;

FIG. 7 is a side view illustrating another optical film, wherein a catalyst layer is formed on a base film of the optical film, according to an embodiment of the present disclosure;

FIG. 8 is a side view illustrating a discontinuous catalyst layer formed after performing a selective passivation process on the catalyst layer of FIG. 7;

FIG. 9 is a side view illustrating a metallic layer formed on side surfaces of the optical film of FIG. 7;

FIG. 10 is a side view illustrating an absorption layer formed on the metallic layer shown in FIG. 9;

FIG. 10A is a side view illustrating the optical film with material filled in channels of the optical film;

FIG. 11 is a side view of yet another optical film according to an embodiment of the present disclosure;

FIG. 12 is a perspective view of a base film of the optical film of FIG. 11 FIG. 13 is a side view illustrating a catalyst layer provided on the base film of FIG. 12;

FIG. 14 is a side view illustrating a discontinuous catalyst layer formed on base film of FIG. 12;

FIG. 15 is a side view illustrating a metallic layer formed on the discontinuous catalyst layer of FIG. 14;

FIG. 15A is a side view illustrating an absorption layer formed on the metallic layer of FIG. 15;

FIG. 15B is a side view illustrating the optical film with material filled in channels of the optical film;

FIG. 16 is a flowchart for a method of manufacturing the optical films of FIGS. 1 and 11 according to an embodiment of the present disclosure; and

FIG. 17 is a flowchart for another method of manufacturing the optical film of FIG. 7 according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the context of present disclosure, the terms “first” and “second” are used as identifiers. Therefore, such terms should not be construed as limiting of this disclosure. The terms “first” and “second” when used in conjunction with a feature or an element can be interchanged throughout the embodiments of this disclosure.

The present disclosure relates to an optical film, such as a light control film, that can perform angular filtering of incident radiation. The optical film can be used in various optical applications, such as imaging applications, displays such as automotive displays, and so forth. The optical film may provide a desired viewing angle. The present disclosure also relates to methods of manufacturing the optical film.

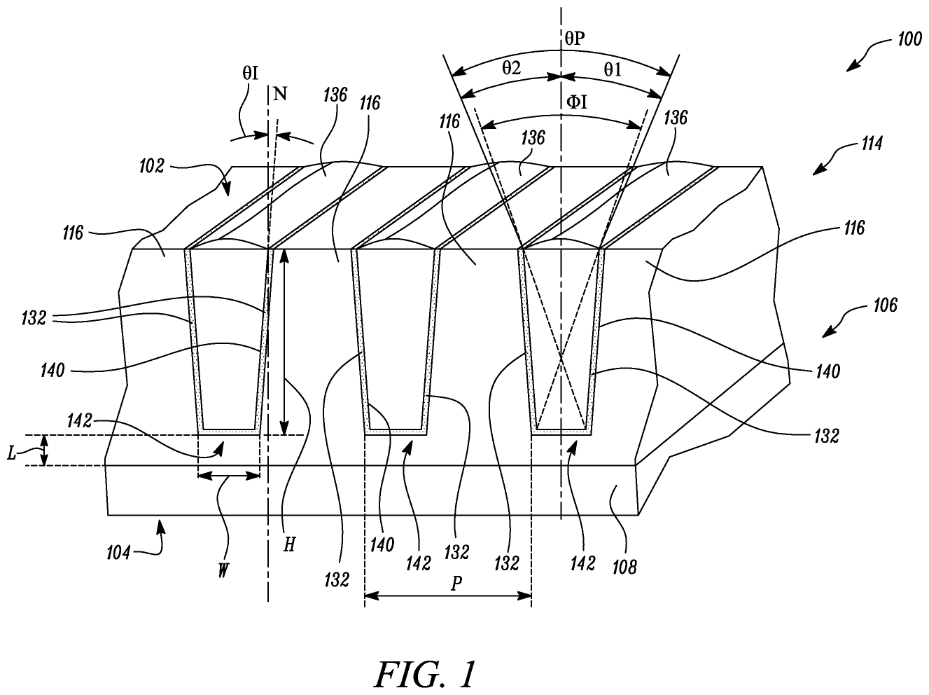

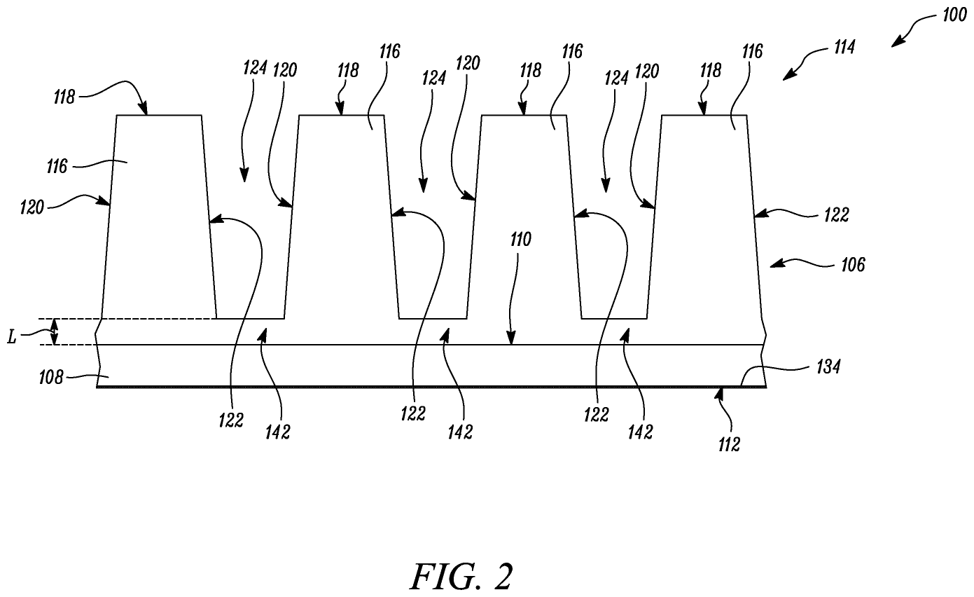

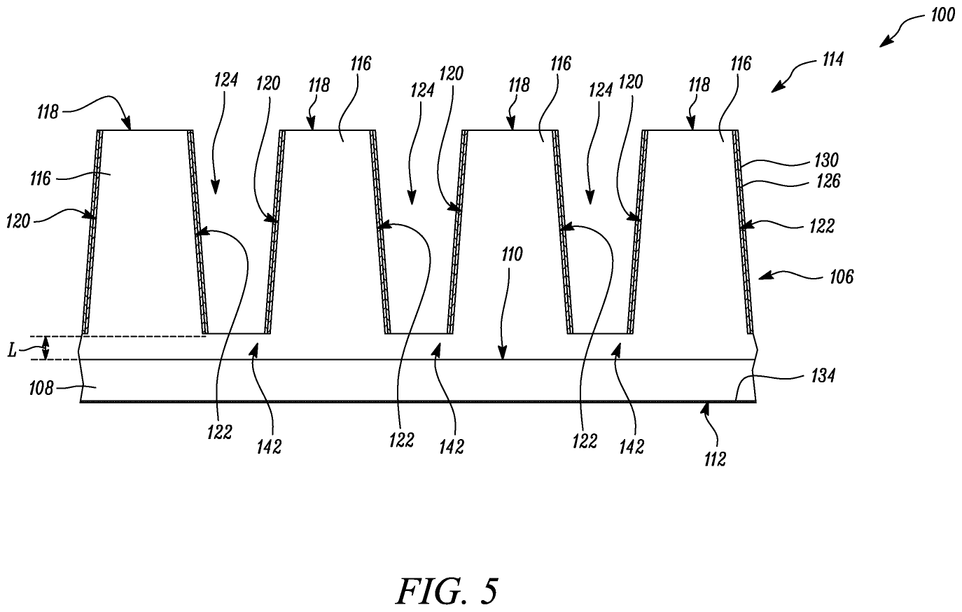

FIG. 1 shows a perspective view of an exemplary optical film 100. The optical film 100 is embodied as a high aspect optical film. The optical film 100 includes an upper major surface 102 and a lower major surface 104. The upper major surface 102 may be facing a viewer, or a light source, or an object to be imaged. In some embodiments, the upper major surface 102 is a light input surface and the lower major surface 104 is a light output surface. The optical film 100 further defines a normal axis “N” that extends from the upper major surface 102 to the lower major surface 104. The normal axis “N” is normal to a plane of the optical film 100. Further, the optical film 100 includes a base film 106. The base film 106 may be formed by micro-replication. The base film 106 includes a substrate 108 and a louver structure 114. In an example, the substrate 108 may be made of polyethylene terephthalate (PET) or polycarbonate (PC). Further, the louver structure 114 includes a plurality of structures 116 and a plurality of channels 124 (shown in FIG. 2). In an example, a land region “L” is defined between the substrate 108 and a base portion 142. A material of the land region “L” is similar to a material of the structures 116. Further, the structures 116 and the channels 124 are embodied as transmissive regions whereas layer 130 (see FIG. 5) or layer 132 are embodied as absorptive regions. The optical film 100 includes alternating transmissive regions, absorptive regions, and interfaces 140 between the transmissive regions and the absorptive regions. Each interface 140 forms an interface angle “θI” with the normal axis “N”. The optical film 100 includes an internal viewing cutoff angle “ΦI” defined by geometry of the alternating transmissive regions and absorptive regions.

The transmissive regions disposed between the absorptive regions have a base width “W”, a height “H”, a pitch “P”, and a polar viewing cutoff angle “θP”. Further, the polar viewing cutoff angle “θP” is equal to a sum of a polar viewing cutoff half angle “01” and a polar viewing cutoff half angle “02” each of which are measured from the normal axis “N” to the upper major surface 102. In some cases, the polar viewing cutoff angle “θP” can be symmetric, and the polar viewing cutoff half angle “θ1” is equal to the polar viewing cutoff half angle “θ2”. In some cases, the polar viewing cutoff angle “θP” can be asymmetric, and the polar viewing cutoff half angle “θ1” is not equal to the polar viewing cutoff half angle “θ2”. The polar viewing angle “θP” can range from 0° (i.e. normal to the upper major surface 102) to 90° (i.e. parallel to the upper major surface 102).

The optical film 100 described herein may have any desired polar viewing cutoff angle “θP”. In one aspect, the polar viewing cutoff angle “θP” ranges from 40° to 90° or even higher. The polar viewing cutoff angle “θP”, can be determined by the parameters “H”, “W”, “P”, and indices of refraction of the materials of the optical film 100.

Referring to FIG. 2, the substrate 108 defines a first surface 110 and a second surface 112 disposed opposite to the first surface 110. The second surface 112 may be facing the viewer, the light source, or the object to be imaged. Further, the base film 106 includes the louver structure 114 disposed on the substrate 108. The louver structure 114 is a microstructure that generally includes projections or protrusions that deviate in profile from an average center line drawn through the microstructure. More particularly, the base film 106 includes the plurality of structures 116 extending from the base portion 142. Each of the plurality of structures 116 defines an upper surface 118 and at least one side surface 120, 122 extending from the corresponding upper surface 118 to the base portion 142. In the illustrated embodiment, each of the structures 116 includes a pair of side surfaces 120, 122. Further, the structures 116 are embodied as ribs herein. Alternatively, the structures 116 may include a number of posts extending from the base portion 142. As illustrated, each of the side surfaces 120, 122 have a tapered profile. Further, the tapered profile of each of the side surfaces 120, 122 tapers towards the second surface 112 of the optical film 100. Alternatively, the side surfaces 120, 122 may have a straight profile. Further, a cross-section of each of the plurality of structures 116 includes at least one of a square shape, a circular shape, a trapezoidal shape, and a polygonal shape. In the illustrated embodiment, the structures 116 have a trapezoidal shape. The structures 116 may be equally spaced apart from each other.

The structures 116 are micro-replicated on the substrate 108. An exemplary micro-replication process is described in U.S. Pat. No. 8,503,122 B2 (Liu et al.). A typical micro-replication process includes depositing a polymerizable composition onto a master negative micro-structured molding surface in an amount barely sufficient to fill the cavities of the master. The cavities are then filled by moving a bead of the polymerizable composition between a preformed base or substrate (for example, the substrate 108) and the master. The composition is then cured. The structures 116 may be formed on the substrate 108 by various methods, such as extrusion, cast-and-cure, coating or some other method.

In some cases, the structures 116 are made of a polymerizable resin. In some cases, the polymerizable resin may be optically clear having a substantially high transmission in a wavelength range from about 300 nanometers (nm) to about 800 nm. The polymerizable resin may include a combination of a first polymerizable component and a second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition may include a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof. The polymerizable resin can be a radiation curable polymeric resin, such as a UV curable resin.

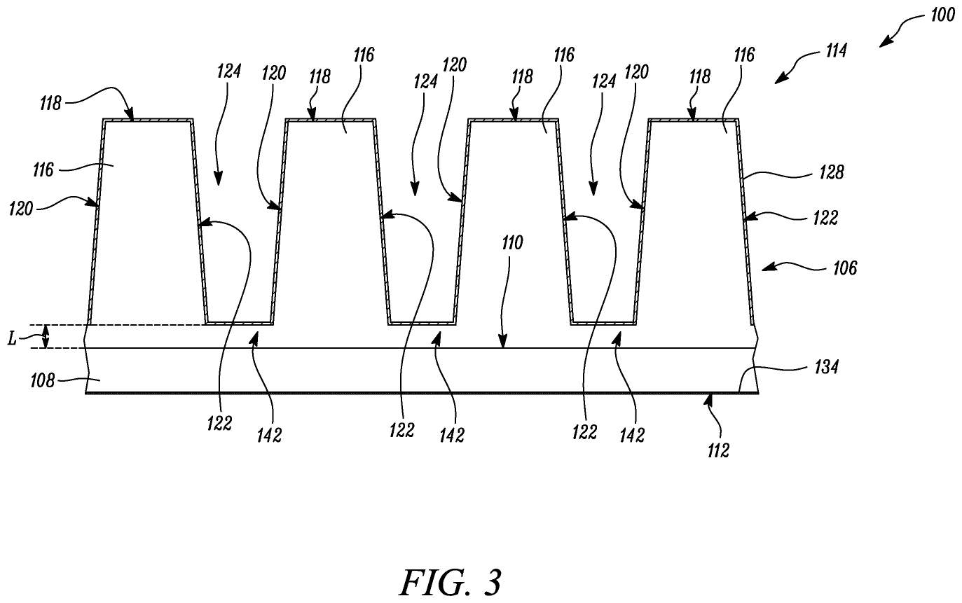

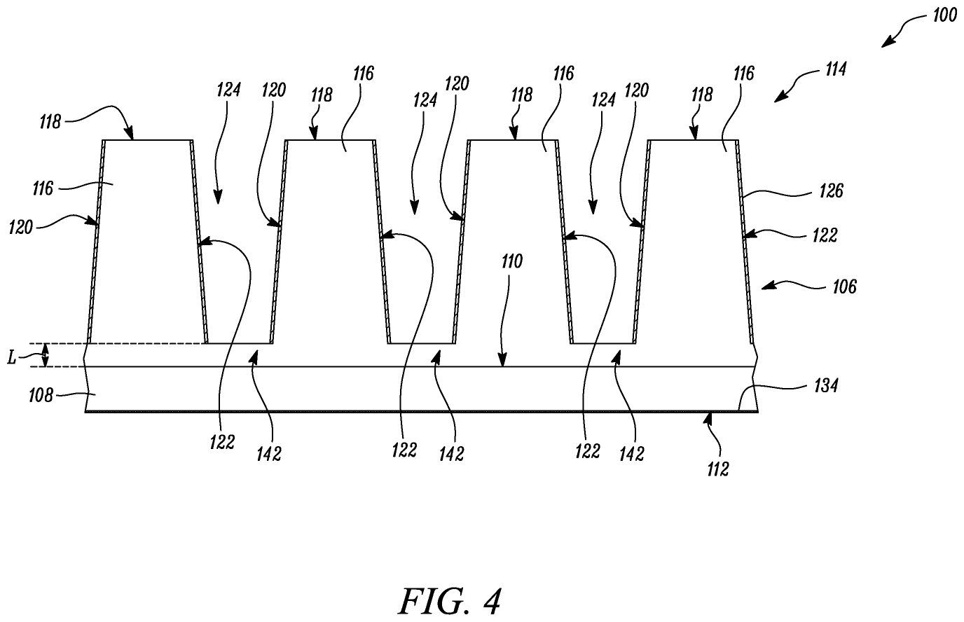

Further, the base film 106 includes the plurality of channels 124 formed between adjacent structures 116 of the plurality of structures 116. Further, each of the channels 124 is filled with a material 136 (see FIG. 1) similar to the material of the structures 116. In some examples, the channels 124 are overfilled with the material 136. Referring to FIG. 3, a catalyst material is deposited on each of the plurality of structures 116 and the base portion 142 to form a catalyst layer 128 thereon. The catalyst material includes at least one of nickel, copper, cobalt, silver, gold, iridium, ruthenium, platinum, and palladium. In some examples, a liner 134 is provided on the second surface 112 of the substrate 108 before disposing the catalyst material. The liner 134 may include an adhesive that removably couples the liner 134 to the second surface 112 of the substrate 108. Referring to FIG. 4, the optical film 100 includes a discontinuous first metallic layer 126 disposed on the at least one side surface 120, 122 of each of the plurality of structures 116. More particularly, the discontinuous first metallic layer 126 is disposed on the pair of side surfaces 120, 122 of each of the plurality of structures 116. The first metallic layer 126 includes at least one of nickel, copper, cobalt, silver, gold, iridium, ruthenium, platinum, and palladium.

The first metallic layer 126 is formed by depositing the catalyst material on each of the plurality of structures 116 and the base portion 142 to form the catalyst layer 128 (see FIG. 3) thereon. Further, the catalyst layer 128 is selectively removed from the upper surface 118 of each of the plurality of structures 116 and the base portion 142 while retaining an activity of the catalyst layer 128 on the at least one side surface 120, 122 of each of the plurality of structures 116. The catalyst layer 128 is selectively removed by a selective etching process. The selective etching process includes a reactive-ion etching process or a sputter etching process. Further, the catalyst layer 128 that is retained on the pair of side surfaces 120, 122 of each of the plurality of structures 116 is embodied as the discontinuous first metallic layer 126.

As shown in FIG. 5, the optical film 100 includes the second metallic layer 130 disposed on the first metallic layer 126 on the at least one side surface 120, 122 of each of the plurality of structures 116. The second metallic layer 130 is hereinafter interchangeably referred to as the metallic layer 130. In the illustrated embodiment, the second metallic layer 130 is disposed on the pair of side surfaces 120, 122 of each of the plurality of structures 116. More particularly, the second metallic layer 130 is an electroless metallic layer. The second metallic layer 130 is generated using a wet chemistry technique. The second metallic layer 130 is generated by electroless metal growth due to a reaction between the catalyst layer 128 and one or more reagents. In one example, the reagent may include a hypophosphite, particularly sodium hypophosphite, but also can include any other suitable reducing agent such as dimethylamine borane. The reagent may include hydrogen, element potassium or sodium (including potassium amalgam and sodium amalgam), element zinc, hydrazine, and some organic reductants. In an example, the reagent is procured from MacDermid Alpha Electronics Solutions (Waterbury, Conn.).

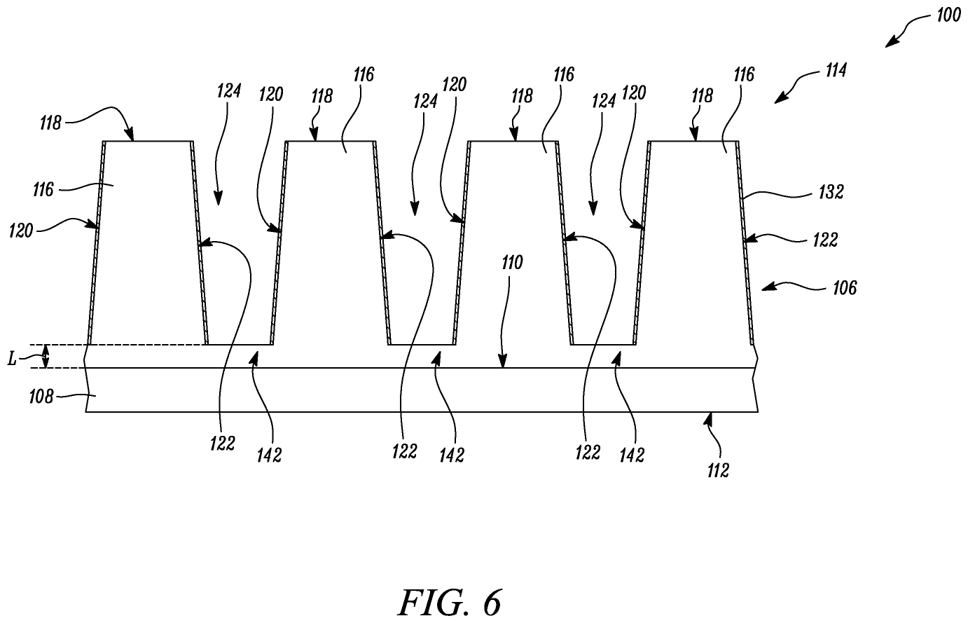

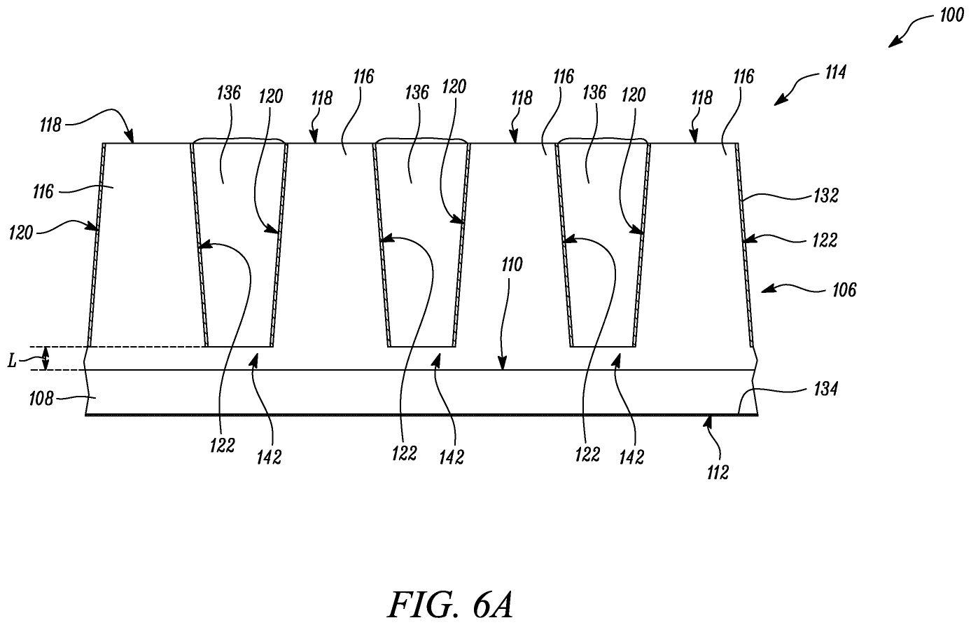

In an example, a thickness of the second metallic layer 130 may be approximately below 1 micron meters (μm). In some examples, the liner 134 is removed from the second surface 112 of the substrate 108 after the formation of the second metallic layer 130. Referring to FIG. 6, the metallic layer 130 (see FIG. 5) may be darkened in order to reduce reflections off of the side surfaces 120, 122. In an example, the metallic layer 130 is darkened by anodization. In another example, as shown in FIG. 6, the optical film 100 includes the absorption layer 132 in order to reduce reflections off of the side surfaces 120, 122. In such an example, the second metallic layer 130 (see FIG. 5) is darkened by micro-etching. The micro-etching process is a mild wet chemical treatment on the second metallic layer 130. The absorption layer 132 created by micro-etching causes a slight decrease in a thickness of the second metallic layer 130 with no voids. Further, the absorption layer 132 formed by micro-etching does not decrease light-blocking function of the second metallic layer 130. The absorption layer 132 formed by micro-etching may roughen and darken the second metallic layer 130, which may be desirable for privacy applications. It should be noted that the absorption layer 132 formed by micro-etching is an optional layer that is formed after forming the metallic layer 130. Referring now to FIG. 6A, after forming the absorption layer 132, each of the channels 124 (see FIG. 5) is filled with the material 136 similar to the material of the structures 116.

The invention is further described with reference to the following examples that explain the process being applied for disposing the second metallic layer 130 on the side surfaces 120, 122. The examples will be explained in reference to FIGS. 1 to 6A.

Unless otherwise specified, the reagents were procured from MacDermid Alpha Electronics Solutions (Waterbury, Conn.). Concentrated hydrochloric acid (HCl) was procured from EMD Millipore (Burlington, Mass.). Argon (UHP compressed gas) was procured from Oxygen Service Company (St. Paul, Minn.).

### Example 1

In this example, the micro-replicated base film 106 was manufactured using Resin A as described in preparative Example 1 of WO Pat. No. 2019118589 (Schmidt et al.). Raw materials used in Resin A are given in Table 1 below.

TABLE 1
Raw materials for Resin A

| Material | Abbreviation | Source |
|---|---|---|
| Aliphatic urethane diacrylate | Photomer 6010 | BASF |
| Viscosity 5900 MPa · s at 60° C. | | |
| Tensile Strength 2060 psi | | |
| Tg = −7° C. | | |
| Ethoxylated (10) bisphenol A diacrylate | SR602 | Sartomer (Exton, PA) |
| Ethoxylated (4) bisphenol A diacrylate | SR601 | Sartomer (Exton, PA) |
| Trimethylolpropane triacrylate | TMPTA | Cytec Industries |
| | | (Woodland Park, NJ) |
| Phenoxyethyl Acrylate | PEA (Etermer 2010) | Eternal Chemical Co., Ltd., |
| | | Kaohsiung, Taiwan |
| 2-Hydroxy-2-methylpropiophenone | Darocur 1173 | BASF Corporation (Florham |
| photoinitiator | | Park, New Jersey) |
| Diphenyl(2,4,6- | TPO | BASF Corporation |
| trimethylbenzoyl)phosphine | | (Florham Park, New Jersey) |
| oxide photoinitiator | | |
| Irgacure 1035 anti-oxidant | I1035 | BASF Corporation |
| | | (Florham Park, New Jersey) |

The composition of Resin A is given below.

| Material | Parts by Weight |
|---|---|
| Photomer 6010 | 60 |
| SR602 | 20 |
| SR601 | 4.0 |
| TMPTA | 8.0 |
| PEA (Etermer 2010) | 8.0 |
| Darocur 1173 | 0.35 |
| TPO | 0.10 |
| I1035 | 0.20 |

Further, if the second surface 112 of the substrate 108 does not include a liner, the liner 134 was applied on the second surface 112 of the substrate 108. The liner 134 may include a laminate Polytetrafluoroethylene (PTFE) tape or other well-adhered liner. Further, the base film 106 was subjected to an etching process. In an example, the base film 106 was etched by a chromic acid etching process. The etching process included immersion in Macuplex LCP etch (i.e., 90% v/v Macuplex LCP etch concentrate, 10% DI water, at 180° Farenheit (F.), for 30 seconds). Further, the base film 106 was then subjected to a cold water rinse for two minutes followed by a hot water rinse for two minutes. Subsequently, the base film 106 was subjected to a conditioning process and conditioned with counter flow rinses from a conditioner, namely MacDermid 4MACuPlex NeutraPrep (i.e., 1.5% v/v MacDermid 4MACuPlex Neutraprep Concentrate, 98.5% v/v DI water, at 120° F., for 5 minutes). The base film 106 was then subjected to a cold water rinse for two minutes followed by a hot water rinse for two minutes.

The base film 106 was then dipped in hydrochloric acid (20% v/v concentrated HCl, at 100° F., for 2 minutes). Further, the base film 106 was activated with a solution of a metal by immersing the base film 106 in an activator solution. In an example, the activator solution included Mactivate 360 (i.e., 0.8% v/v Mactivate 360 concentrate, 20% v/v concentrated HCl, 79.8% v/v DI water, at 100° F., for 5 minutes) which is an ultra-low concentration, precious metal liquid catalyst. The base film 106 was then subjected to a cold water rinse for two minutes followed by air drying. The base film 106 was then subjected to a selective etching process, specifically a sputter etching process using a reactor as described in U.S. Pat. No. 8,460,568B2; etching was carried out at 5000 W power on a 1.25 m² (surface area) cylindrical electrode with an Argon flow rate of 400 SCCM, resulting in a process pressure of approximately 1 mTorr. A catalyst material available under the trademark “Niklad 262” (i.e., 10% v/v Niklad 262 concentrate, 90% v/v DI water, at 110° F., for 3 minutes) was then applied to the base film 106 by dipping the base film 106 therein. The catalyst material was retained on surfaces of the base film 106 to be plated, thereby forming the catalyst layer 128. The base film 106 was then subjected to a cold water rinse for two minutes. Further, the liner 134 was peeled off from the second surface 112 of the substrate 108 of the base film 106.

The base film 106 was then subjected to electroless plating by immersing the base film 106 in an electroless strike bath, namely Macuplex J64 (i.e., 7.0% v/v Macuplex J60 concentrate, 3.0% v/v Macuplex J61 concentrate, 1.5% v/v Macuplex J63F concentrate, 88.5% v/v DI water, at 100° F., for 30 seconds to 10 minutes), that is designed for electroless plating on plastic applications. The base film 106 was then subjected to cold water rinse for two minutes. Following this treatment, the base film 106 was examined. The examination confirmed that the side surfaces 120, 122 were covered with the second metallic layer 130. Next, the channels 124 were filled with the material 136 similar to the material of the structures 116, i.e., Resin A.

### Example 2

In this example, all the steps mentioned in Example 1 were followed. However, etch time for the etching process was varied and no liner was placed on the substrate 108. On examining the final product, it was observed that the etch times over a predefined threshold of about 30 seconds tends to dissolve the replicated acrylate layer, resulting in no structured surface for the plating.

### Example 3

In this example, all the steps mentioned in Example 1 were followed. However, no liner was provided on the second surface 112 of the substrate 108. On examining the final product, it was concluded that it may be desirable to mask the second surface 112 of the substrate 108 with the liner 134 to prevent complete transmission loss due to complete plating of the second surface 112 of the substrate 108 by a layer of electroless metal coating.

### Example 4

In this example, all the steps mentioned in Example 1 were followed but electroless plating time during the electroless plating was varied. It was observed that the base film 106 becomes visibly darkened within 15 seconds and was completely metallic/reflective in plated areas within 2 minutes. Bubbling, that is indicative of electroless plating, was visible for the full duration of the immersions. When the base film 106 was immersed for a longer time, the base film 106 was thickly plated and did not exhibit sufficient transmission to the unaided eye, when viewed perpendicularly.

### Example 5

In this example, the micro-replicated base film 106 manufactured using Resin A were used. Further, if the second surface 112 of the substrate 108 does not include a liner, the liner 134 was applied on the second surface 112 of the substrate 108. The liner 134 may include a laminate Polytetrafluoroethylene (PTFE) tape or other well-adhered liner. Further, the base film 106 was subjected to an etching process. In an example, the base film 106 was etched by a chromic acid etching process. The etching process included Macuplex LCP etch (i.e., 90% v/v Macuplex LCP etch concentrate, 10% DI water, at 180° F., for 30 seconds). Further, the base film 106 was then subjected to a cold water rinse for two minutes followed by a hot water rinse for two minutes. Subsequently, the base film 106 was subjected to a conditioning process and conditioned with counter flow rinses from a conditioner, namely MacDermid 4MACuPlex NeutraPrep (i.e., 1.5% v/v MacDermid 4MACuPlex Neutraprep Concentrate, 98.5% v/v DI water, at 120° F., for 5 minutes). The base film 106 was then subjected to a cold water rinse for two minutes followed by a hot water rinse for two minutes.

The base film 106 was then dipped in hydrochloric acid (20% v/v concentrated HCl, at 100° F., for 2 minutes). Further, the base film 106 was activated with a solution of a metal by immersing the base film 106 in an activator solution. In an example, the activator solution included Mactivate 360 (i.e., 0.8% v/v Mactivate 360 concentrate, 20% v/v concentrated HCl, 79.8% v/v DI water, at 100° F., for 5 minutes) which is an ultra-low concentration, precious metal liquid catalyst. The base film 106 was then subjected to a cold water rinse for two minutes followed by air drying. The base film 106 was then subjected to a selective etching process as described in Example 1. A catalyst material available under the trademark “Niklad 262” (i.e., 10% v/v Niklad 262 concentrate, 90% v/v DI water, at 110° F., for 3 minutes) was then applied to the base film 106 by dipping the base film 106 therein. The catalyst material was retained on surfaces of the base film 106 to be plated, thereby forming the catalyst layer 128. The base film 106 was then subjected to a cold water rinse for two minutes. Further, the liner 134 was peeled off from the second surface 112 of the substrate 108. The base film 106 was then subjected to electroless plating by immersing the base film 106 in an electroless strike bath, namely Macuplex J64 (i.e., 7.0% v/v Macuplex J60 concentrate, 3.0% v/v Macuplex J61 concentrate, 1.5% v/v Macuplex J63F concentrate, 88.5% v/v DI water, at 100° F., for 30 seconds to 10 minutes), that is designed for electroless plating on plastic applications. The base film 106 was then subjected to two cold water rinses for two minutes.

The base film 106 was then subjected to organically stabilized lead and cadmium-free semi-bright process by immersing the base film 106 in Niklad 824 solution (i.e., 3% v/v Barrett SNR-24 concentrate, 20% v/v Niklad 824 concentrate, 77% v/v DI water, at 190° F.) to darken or form the absorption layer 132 on the second metallic layer 130. The base film 106 was immersed in a solution during the semi-bright process to form the absorption layer 132. In some examples, the electroplating time and a time of the semi-bright process may be adjusted to achieve desired thickness of the second metallic layer 130. The base film 106 was then rinsed twice with cold water.

Further, the base film 106 was subjected to another treatment that forms black deposits where Niklad ELV 824 was used as a top layer. More particularly, the base film 106 was immersed in NiKlad Eclipse (i.e., 50% v/v NiKlad Eclipse concentrate, 48% v/v DI water, 2% v/v concentrated HCl, at 77° F., for 1 to 2 minutes) which is an oxidizing solution designed to provide black deposits when used with a duplex electroless coating where the top layer was the NiKlad ELV 824. The base film 106 was then rinsed twice with cold water and then baked at a low temperature (between 100° F. and 110° F.) to dry and firm up the black deposits. Following this treatment, the base film 106 was examined. On examining the base film 106, it was found that the second metallic layer 130 has well adhered to the side surfaces 120, 122, and the reflective metal was converted to a less reflective, black material. Further, the liner 134 was peeled off from the second surface 112 of the substrate 108 and the channels 124 were filled with the material 136 similar to the material of the structures 116, i.e., Resin A.

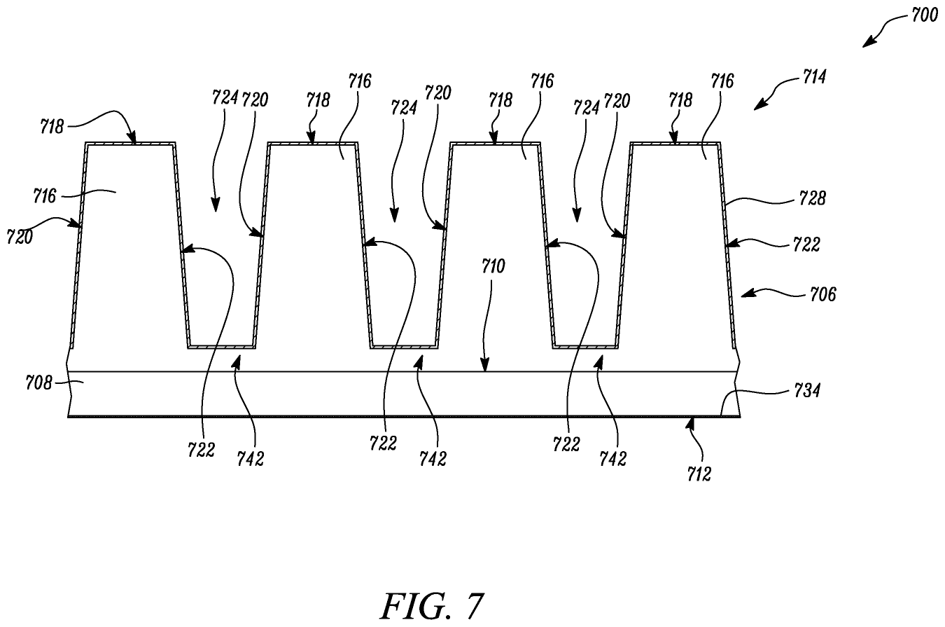

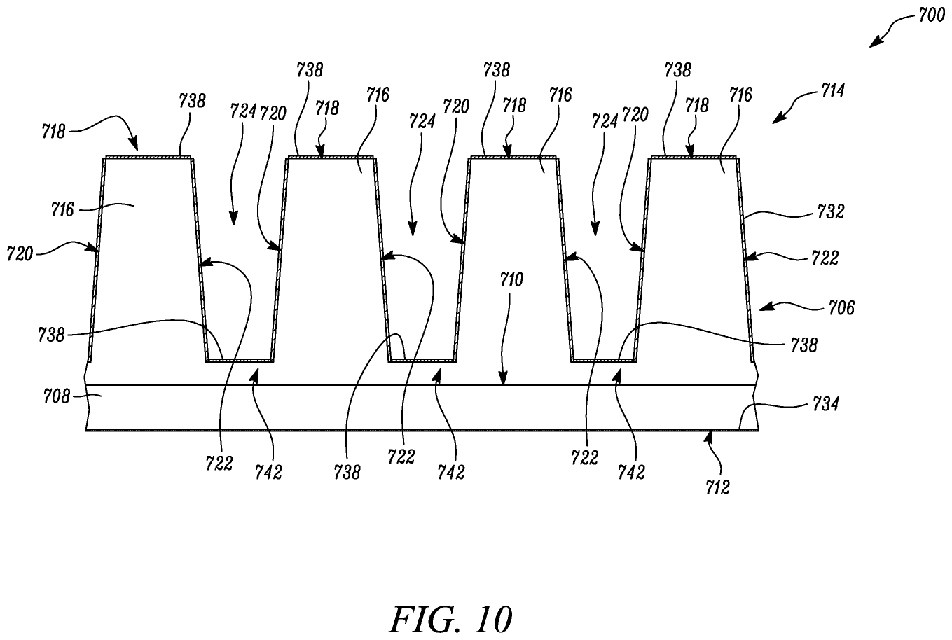

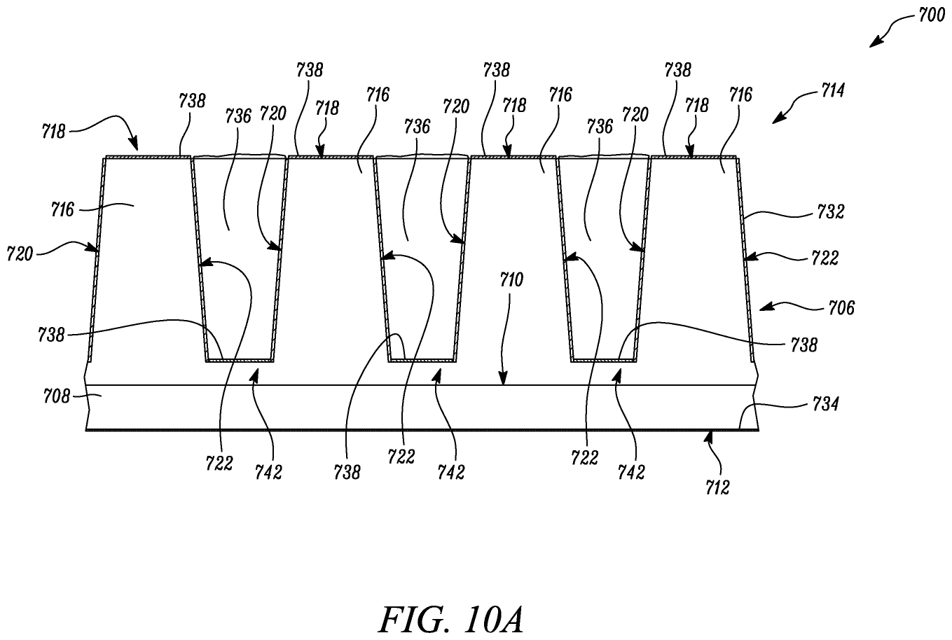

Referring now to FIG. 7, another base film 706 associated with an optical film 700 is illustrated. The base film 706 is similar to the base film 106 described in relation to FIGS. 1 to 6A. The base film 706 may be formed by micro-replication. The base film 706 includes a substrate 708, a plurality of structures 716, and a plurality of channels 724 similar to the substrate 108, the plurality of structures 116, and the plurality of channels 124, respectively, of the base film 106. Further, each of the channels 724 is filled with a material 736 (see FIG. 10) similar to a material of the structures 716. In some examples, the channels 724 are overfilled with the material 736. The substrate 708 defines a first surface 710 and a second surface 712 disposed opposite to the first surface 710. Each of the plurality of structures 716 defines an upper surface 718 and at least one side surface 720, 722 extending from the corresponding upper surface 718 to a base portion 742.

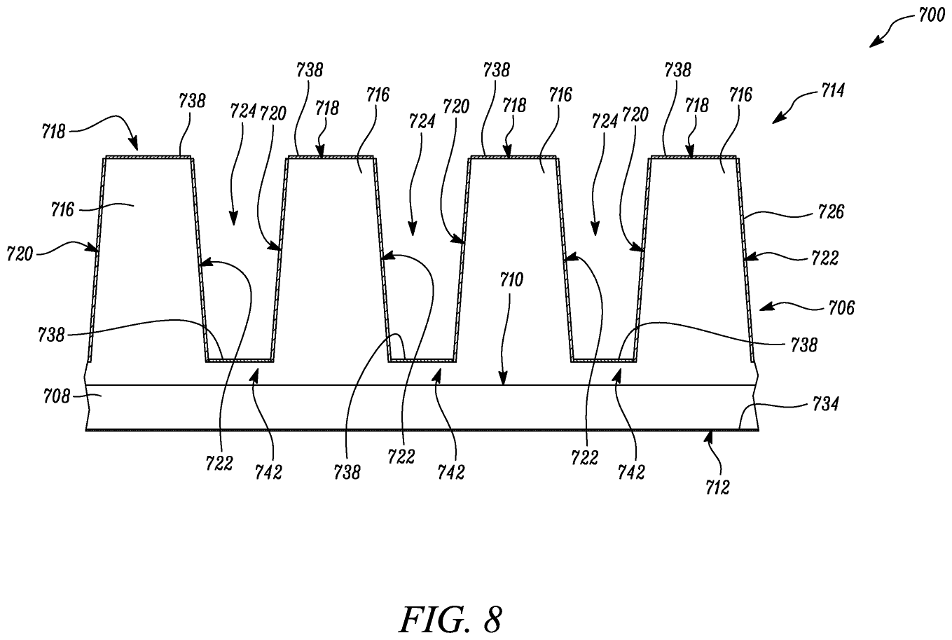

Further, a catalyst material is deposited on each of the plurality of structures 716 and the base portion 742 to form a catalyst layer 728 thereon. The catalyst material includes at least one of nickel, copper, cobalt, silver, gold, iridium, ruthenium, platinum, and palladium. In some examples, a liner 734 is provided on the second surface 712 of the substrate 708 before disposing the catalyst material. Referring now to FIG. 8, the optical film 700 includes a discontinuous first metallic layer 726 disposed on at least one side surface 720, 722 of each of the plurality of structures 716. More particularly, the discontinuous first metallic layer 726 is disposed on the pair of side surfaces 720, 722 of each of the plurality of structures 716. The first metallic layer 726 includes at least one of nickel, copper, cobalt, silver, gold, iridium, ruthenium, platinum, and palladium.

The first metallic layer 726 is formed by depositing the catalyst material on each of the plurality of structures 716 and the base portion 742 to form the catalyst layer 728 thereon. Further, the catalyst layer 728 is selectively passivated on the upper surface 718 of each of the plurality of structures 716 and the base portion 742 while retaining an activity of the catalyst layer 728 on the at least one side surface 720, 722 of each of the plurality of structures 716. More particularly, passivated layers 738 are formed on the upper surface 718 of each of the plurality of structures 716 and the base portion 742. Thus, the activity of the catalyst layer 728 is retained only on the side surfaces 720, 722 of each of the plurality of structures 716. The catalyst layer 728 is selectively passivated using a selective passivation process. The selective passivation process is a plasma enhanced chemical vapor deposition process. Further, the catalyst layer 728 that is retained on the pair of side surfaces 720, 722 of each of the plurality of structures 716 is embodied as the discontinuous first metallic layer 726.

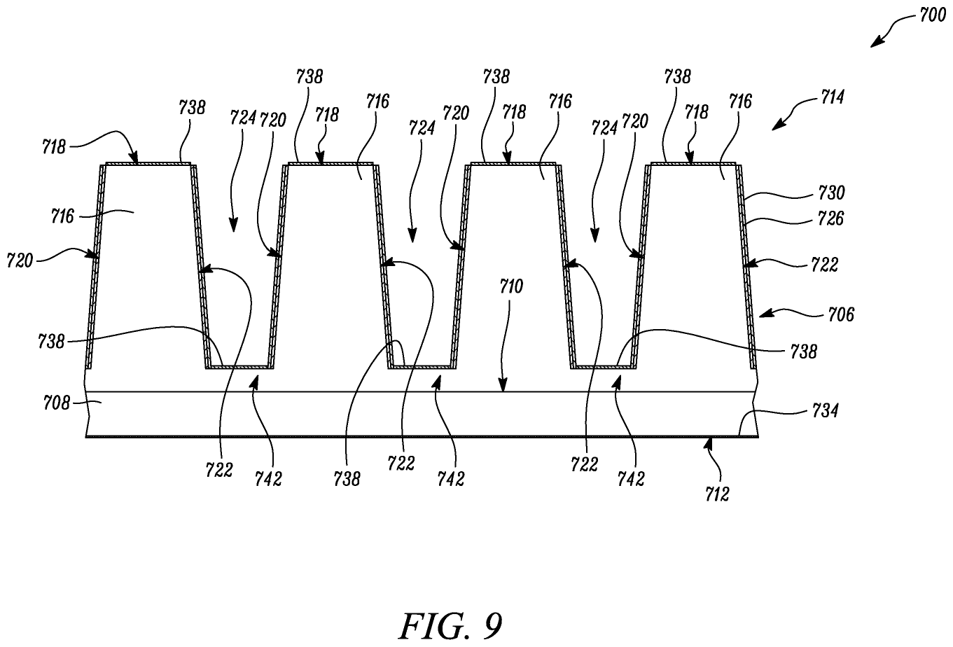

Referring to FIG. 9, the optical film 700 includes a metallic layer 730 formed on the at least one side surface 720, 722 of each of the plurality of structures 716. The metallic layer 730 may be hereinafter interchangeably referred to the second metallic layer 730. In the illustrated embodiment, the metallic layer 730 is formed on the pair of side surfaces 720, 722 of each of the plurality of structures 716. More particularly, the metallic layer 730 is an electroless metallic layer. The metallic layer 730 is generated using a wet chemistry technique.

The metallic layer 730 is generated by electroless metal growth due to a reaction between the catalyst layer 728 and one or more reagents. In one example, the reagent may include a hypophosphite, particularly sodium hypophosphite, but also can be any other suitable reducing agent such as dimethylamine borane. The reagent may include hydrogen, element potassium or sodium (including potassium amalgam and sodium amalgam), element zinc, hydrazine, and some organic reductants. In an example, the reagent is procured from MacDermid Alpha Electronics Solutions (Waterbury, Conn.). In some examples, the liner 734 is removed from the second surface 712 of the substrate 708 after the formation of the metallic layer 730. Further, in some examples, the metallic layer 730 is darkened. In an example, the metallic layer 730 is darkened by anodization.

In another example, as shown in FIG. 10, the optical film 700 includes an absorption layer 732 in order to reduce reflections off of the side surfaces 720, 722. In such an example, the metallic layer 730 (see FIG. 9) is darkened by micro-etching A function and forming technique of the absorption layer 732 is similar to the function and the forming technique of the absorption layer 132 of the optical film 100 shown in FIG. 6. It should be noted that the absorption layer 732 formed by micro-etching is an optional layer that is formed after forming the metallic layer 730. Referring now to FIG. 10A, after forming the absorption layer 732, each of the channels 724 (see FIG. 9) is filled with the material 736 similar to the material of the structures 716.

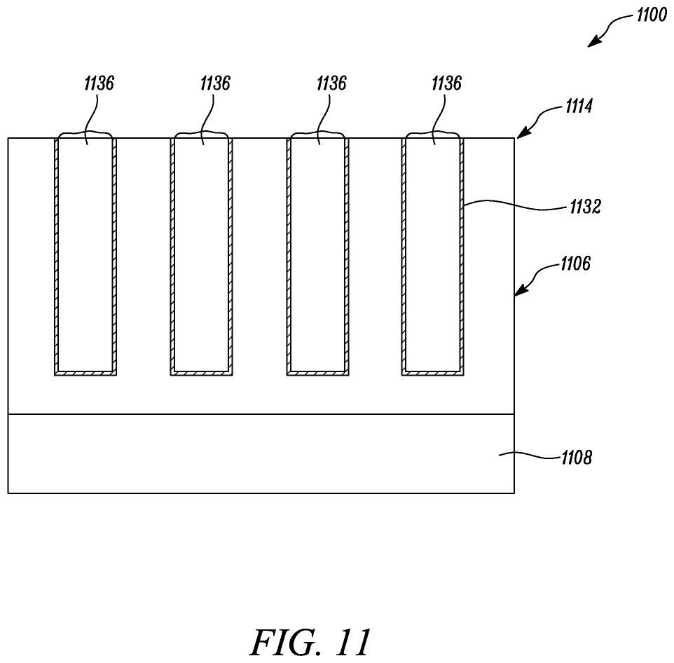

Referring now to FIG. 11, a side view of another exemplary optical film 1100 is illustrated. Further, the optical film 1100 includes a base film 1106. The base film 1106 is formed by micro-replication. The base film 1106 includes a substrate 1108 similar to the substrate 108 of the base film 106 explained in relation to FIGS. 1 to 6A. The substrate 1108 defines a first surface 1110 (shown in FIGS. 13, 14, and 15) and a second surface 1112 (shown in FIGS. 13, 14, and 15) disposed opposite to the first surface 1110.

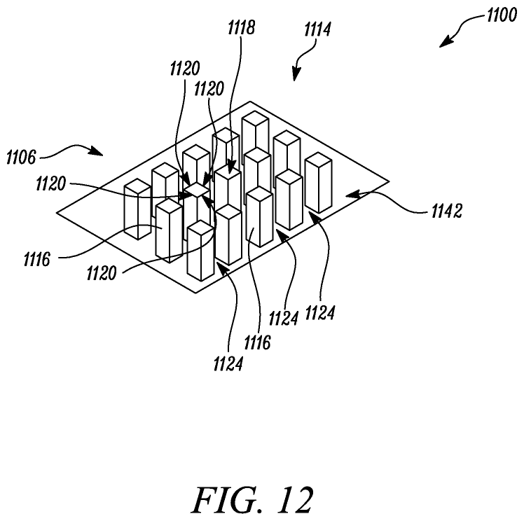

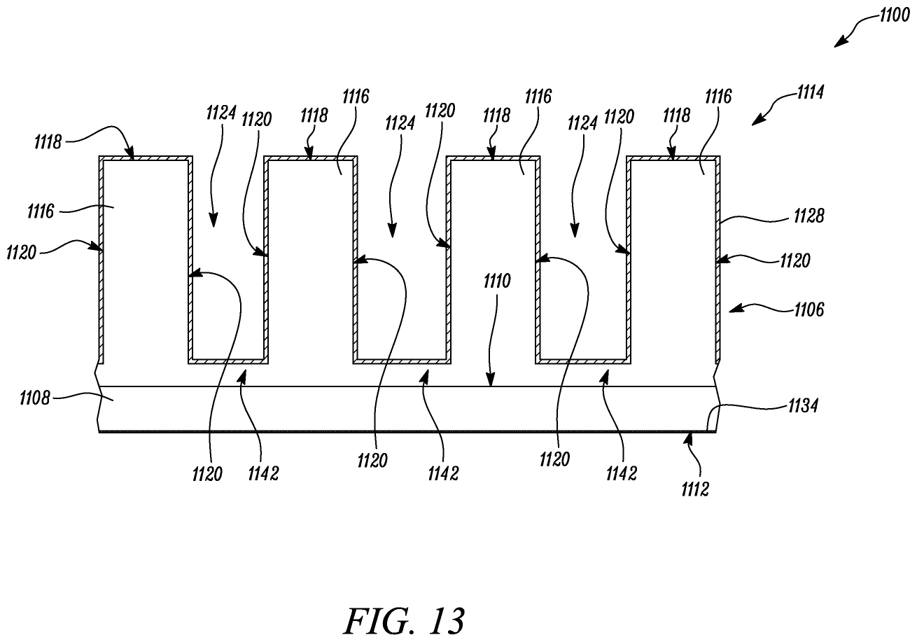

Referring now to FIG. 12, the base film 1106 includes a louver structure 1114. The louver structure 1114 is a microstructure that generally includes projections or protrusions that deviate in profile from an average center line drawn through the microstructure. More particularly, the base film 1106 includes a plurality of structures 1116 extending from a base portion 1142. Each of the plurality of structures 1116 defines an upper surface 1118 and at least one side surface 1120 extending from the corresponding upper surface 1118 to the base portion 1142. In the illustrated embodiment, each of the structures 1116 includes four side surfaces 1120. Further, the structures 1116 are embodied as three-dimensional structures, such as posts. Each post is surrounded by a number of posts. The structures 1116 are arranged in a number of rows and columns. Further, a cross-section of each of the plurality of structures 1116 includes at least one of a square shape, a circular shape, a trapezoidal shape, and a polygonal shape. In the illustrated embodiment, the cross-section of each of the structures 1116 includes a square shape. The structures 1116 may be equally spaced apart from each other. A method of manufacturing the structures 1116 and a material of the structures 1116 is similar to the method of manufacturing the structures 116 and the material of the structures 116 described in relation to FIGS. 1 to 6A. Further, the base film 1106 includes a plurality of channels 1124 formed between adjacent structures 1116 of the plurality of structures 1116. Further, each of the channels 1124 is filled with a material 1136 (shown in FIG. 11) similar to the material of the structures 1116. In some examples, the channels 1124 are overfilled with the material 1136.

Referring to FIG. 13, a catalyst material is deposited on each of the plurality of structures 1116 and the base portion 1142 to form a catalyst layer 1128 thereon. The catalyst material includes at least one of nickel, copper, cobalt, silver, gold, iridium, ruthenium, platinum, and palladium. In some examples, a liner 1134 is provided on the second surface 1112 of the substrate 1108 before disposing the catalyst material.

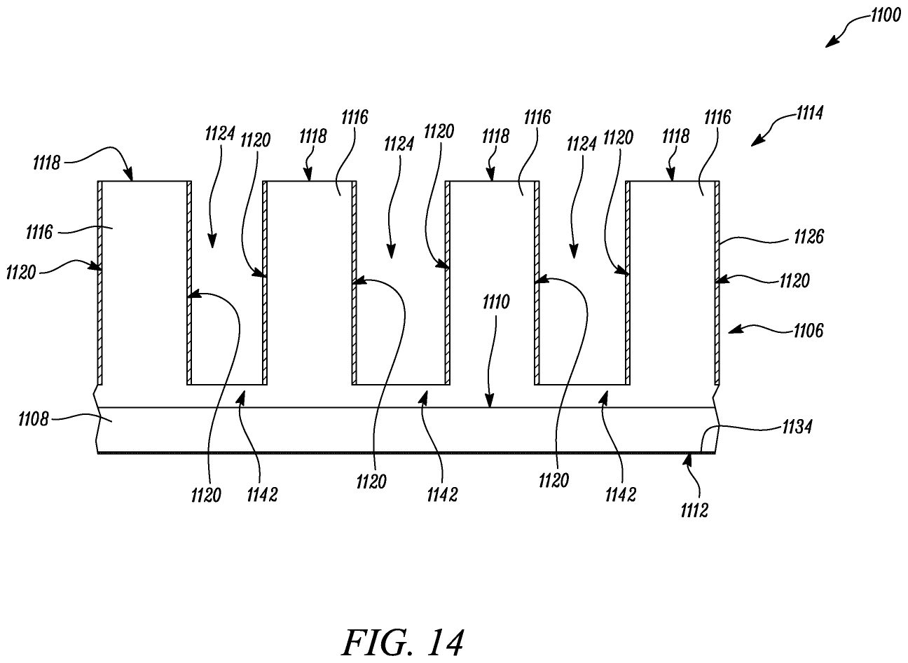

Referring to FIG. 14, the optical film 1100 includes a discontinuous first metallic layer 1126 disposed on the at least one side surface 1120 of each of the plurality of structures 1116. More particularly, the discontinuous first metallic layer 1126 is disposed on each of the side surfaces 1120 of each of the plurality of structures 1116. The first metallic layer 1126 includes at least one of nickel, copper, cobalt, silver, gold, iridium, ruthenium, platinum, and palladium.

The first metallic layer 1126 is formed by depositing the catalyst material on each of the plurality of structures 1116 and the base portion 1142 to form the catalyst layer 1128 (see FIG. 13) thereon. Further, the catalyst layer 1128 is selectively removed from the upper surface 1118 of each of the plurality of structures 1116 and the base portion 1142 while retaining an activity of the catalyst layer 1128 on the at least one side surface 1120 of each of the plurality of structures 1116. The catalyst layer 1128 is selectively removed by a selective etching process. The selective etching process includes a reactive-ion etching process or a sputter etching process. Further, the catalyst layer 1128 that is retained on each of the side surfaces 1120 of each of the plurality of structures 1116 is embodied as the discontinuous first metallic layer 1126.

Alternatively, the catalyst layer 1128 may be selectively passivated on the upper surface 1118 of each of the plurality of structures 1116 and the base portion 1142 while retaining the activity of the catalyst layer 1128 on the side surfaces 1120 of each of the plurality of structures 1116. More particularly, the activity of the catalyst layer 1128 is retained only on the side surfaces 1120 of each of the plurality of structures 1116. The catalyst layer 1128 may be selectively passivated using a selective passivation process. The selective passivation process may be a plasma enhanced chemical vapor deposition process. Further, the catalyst layer 1128 that is retained on the side surfaces 1120 of each of the plurality of structures 1116 is embodied as the discontinuous first metallic layer 1126.

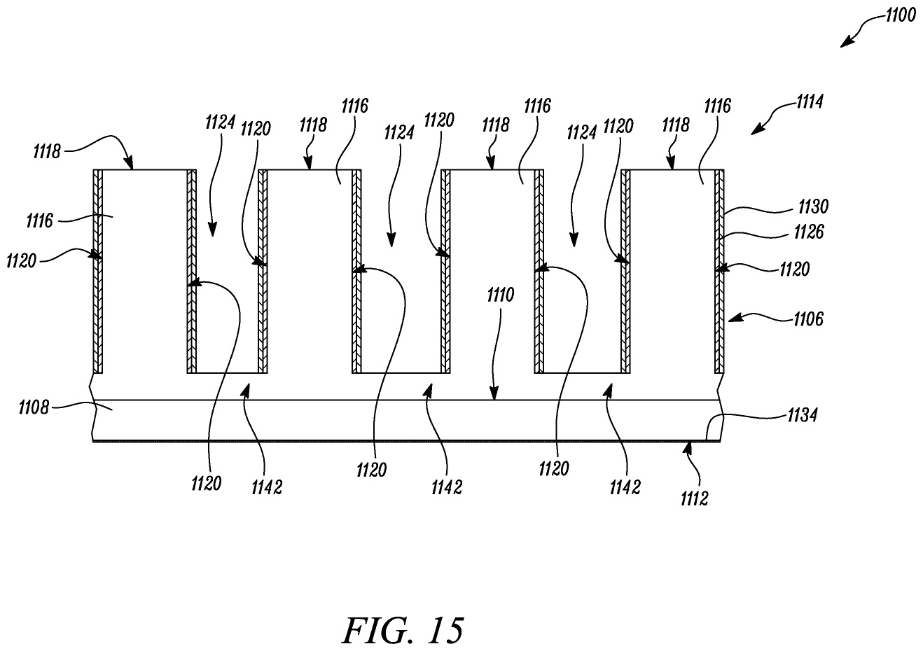

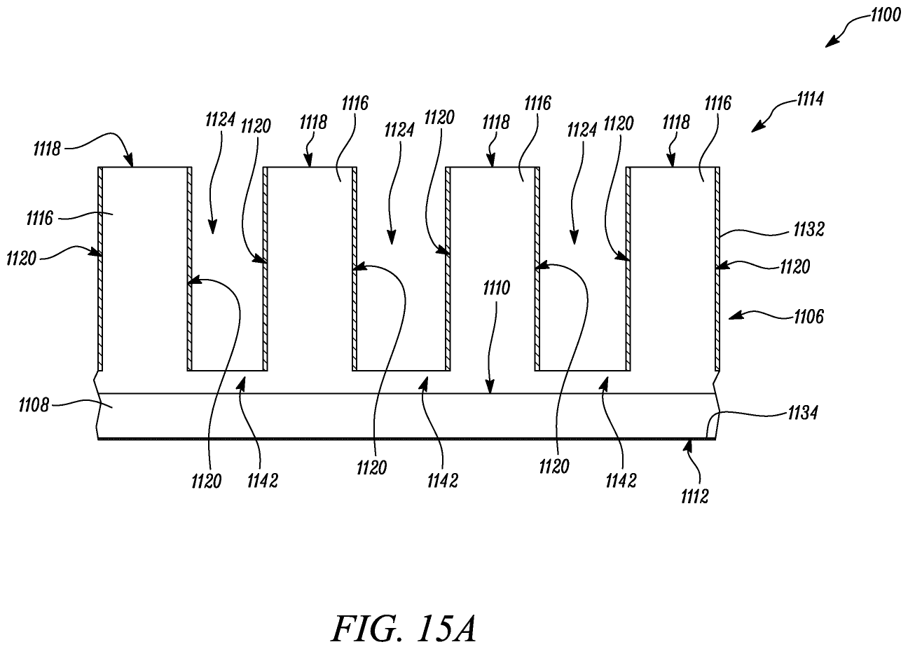

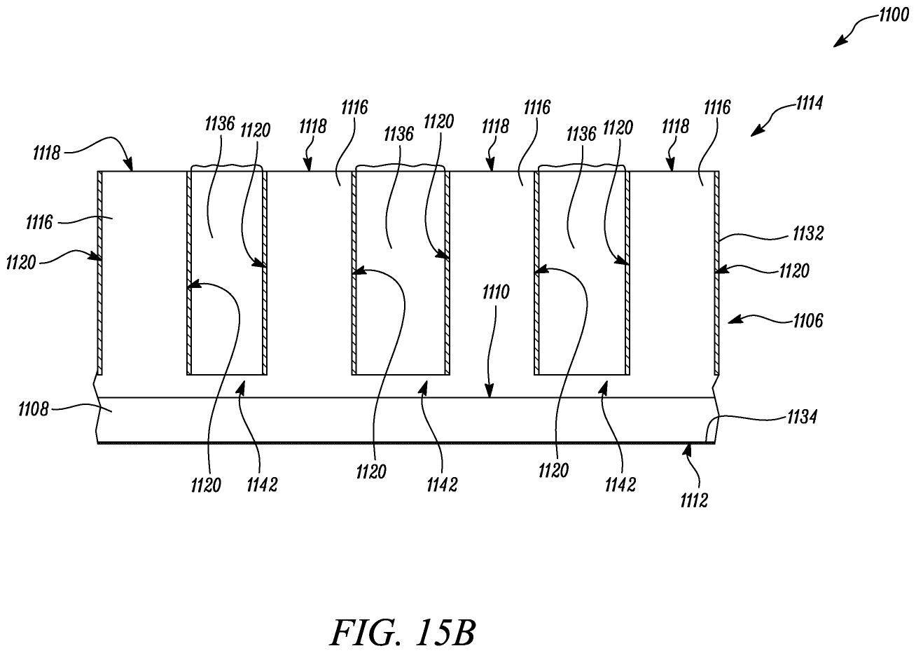

As shown in FIG. 15, the optical film 1100 includes a second metallic layer 1130 disposed on the first metallic layer 1126 on the side surfaces 1120 of each of the plurality of structures 1116. In the illustrated embodiment, the second metallic layer 1130 is formed on the side surfaces 1120 of each of the plurality of structures 1116. More particularly, the second metallic layer 1130 is an electroless metallic layer. The second metallic layer 1130 is generated using a traditional wet chemistry technique. The second metallic layer 1130 is generated by electroless metal growth due to a reaction between the catalyst layer 1128 and one or more reagents. In one example, the reagent may include a hypophosphite, particularly sodium hypophosphite, but also can be any other suitable reducing agent such as dimethylamine borane. The reagent may include hydrogen, element potassium or sodium (including potassium amalgam and sodium amalgam), element zinc, hydrazine, and some organic reductants. In an example, the reagent is procured from MacDermid Alpha Electronics Solutions (Waterbury, Conn.).

In some examples, the liner 1134 is removed from the second surface 1112 after the formation of the metallic layer 1130. Further, in some examples, the metallic layer 1130 is darkened. In an example, the metallic layer 1130 is darkened by anodization. In another example, as shown in FIG. 15A, the optical film 1100 includes an absorption layer 1132 in order to reduce reflections off of the side surfaces 1120. In such an example, the metallic layer 1130 (see FIG. 15) is darkened by micro-etching. A function and forming technique of the absorption layer 1132 is similar to the function and the forming technique of the absorption layer 132 of the optical film 100 shown in FIG. 6. It should be noted that the absorption layer 1132 formed by micro-etching is an optional layer that is formed after forming the metallic layer 1130. Referring now to FIG. 15B, forming the absorption layer 1132, each of the channels 1124 (see FIG. 15A) is filled with the material 1136 similar to the material of the structures 1116.

The optical films 100, 700, 1100 described above are embodied as high transmission optical films that may be used in automotive display applications. Further, these high transmission optical films 100, 700, 1100 may be useful as window films. The window films may permit outside viewing at specific angles and may prevent undesired heating or glare from sunlight. Similarly, the optical films 100, 700, 1100 may be used as angular control filters for optical sensors.

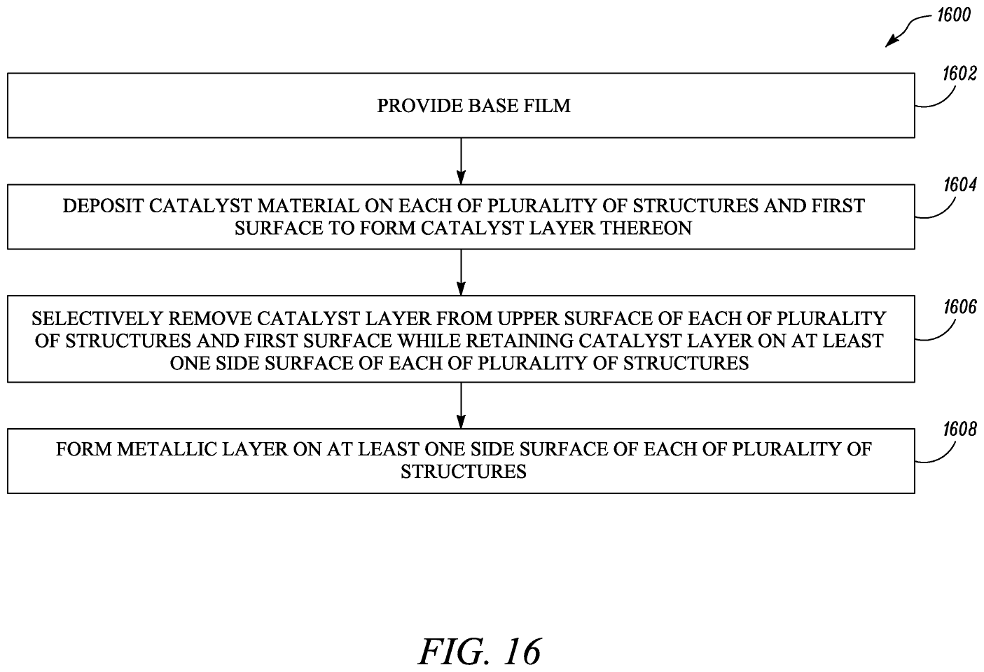

FIG. 16 is a flowchart for a method of manufacturing the optical film 110, 1100. At step 1602, the base film 116, 1106 is provided. The base film 116, 1106 includes the substrate 118, 1108 defining the first surface 110, 1110 and the second surface 112, 1112 disposed opposite to the first surface 110, 1110. Further, the base film 116, 1106 includes the plurality of structures 116, 1116 extending from the base portion 142, 1142. Each of the plurality of structures 116, 1116 defines the upper surface 118, 1118 and the at least one side surface 120, 122, 1120 extending from the corresponding upper surface 118, 1118 to the base portion 142, 1142. The cross-section of each of the plurality of structures 116, 1116 includes at least one of a square shape, a circular shape, a trapezoidal shape, and a polygonal shape. Further, the optical film 110, 1100 includes the plurality of channels 124, 1124 formed between adjacent structures 116, 1116 of the plurality of structures 116, 1116. Each of the plurality of channels 124, 1124 is filled with the material 136, 1136 similar to the material of the structures 116, 1116. The base film 116, 1106 may be formed by micro-replication.

At step 1604, the catalyst material is deposited on each of the plurality of structures 116, 1116 and the base portion 142, 1142 to form the catalyst layer 128, 1128, thereon. The catalyst material includes at least one of nickel, copper, cobalt, silver, gold, iridium, ruthenium, platinum, and palladium. Further, the liner 134, 1134 is provided on the second surface 112, 1112 of the substrate 118, 1108. More particularly, the liner 134, 1134 is provided before depositing the catalyst material. At step 1606, the catalyst layer 128, 1128, is selectively removed from the upper surface 118, 1118 of each of the plurality of structures 116, 1116 and the base portion 142, 1142 while retaining the activity of the catalyst layer 128, 1128, on the at least one side surface 160, 162, 1120 of each of the plurality of structures 116, 1116. The catalyst layer 128, 1128 is selectively removed by a reactive-ion etching process or a sputter etching process. At step 1608, the metallic layer 130, 1130 is formed on the at least one side surface 160, 162, 1120 of each of the plurality of structures 116, 1116. The metallic layer 130, 1130 is generated by electroless metal growth due to a reaction between the catalyst layer 128, 1128, and one or more reagents. Moreover, the liner 134, 1134 is removed from the second surface 112, 1112 after the formation of the metallic layer 130, 1130. Further, in an embodiment, the metallic layer 130, 1130 is darkened. In an example, the metallic layer 130, 1130 is darkened by anodization. In another example, the absorption layer 132, 1132 is formed on the metallic layer by micro-etching. More particularly, the metallic layer 130, 1130 is darkened by micro-etching.

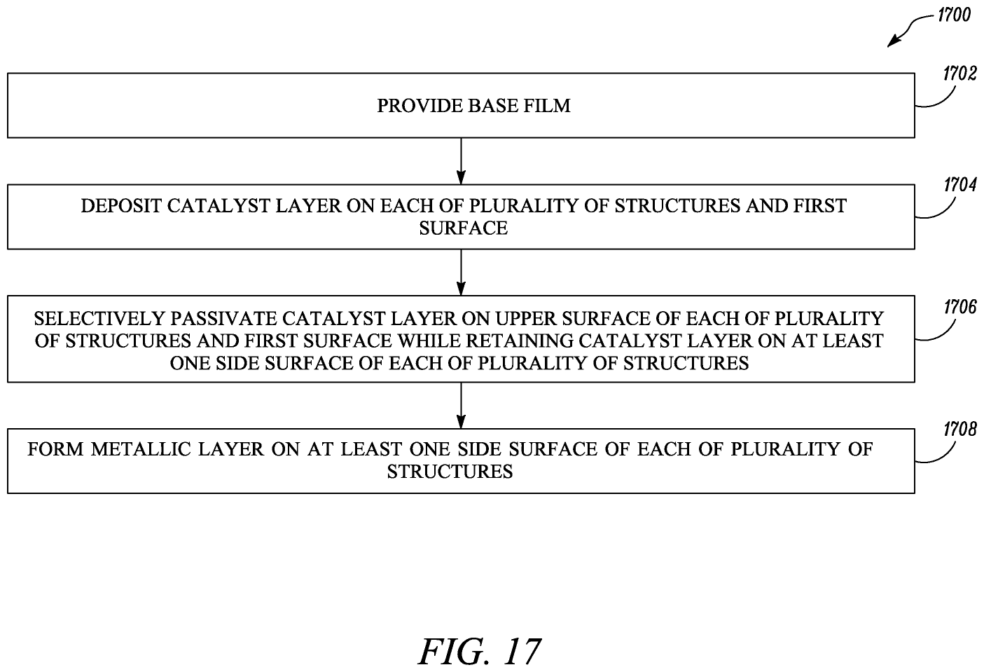

FIG. 17 is a flowchart for a method of manufacturing the optical film 700. At step 1702, the base film 706 is provided. The base film 706 includes the substrate 708 defining the first surface 710 and the second surface 712 disposed opposite to the first surface 710. Further, the base film 706 includes the plurality of structures 716 extending from the base portion 742. Each of the plurality of structures 716 defines the upper surface 718 and the at least one side surface 720, 722 extending from the corresponding upper surface 718 to the base portion 742. The cross-section of each of the plurality of structures 716 includes at least one of a square shape, a circular shape, a trapezoidal shape, and a polygonal shape. Further, the optical film 700 includes the plurality of channels 724 formed between adjacent structures 716 of the plurality of structures 716. Each of the plurality of channels 724 is filled with the material 736 similar to the material of the structures 716. The base film 706 may be formed by micro-replication.

At step 1704, the catalyst material is deposited on each of the plurality of structures 716 and the base portion 742 to form the catalyst layer 728 thereon. The catalyst material includes at least one of nickel, copper, cobalt, silver, gold, iridium, ruthenium, platinum, and palladium. At step 1706, the catalyst layer 728 is selectively passivated on the upper surface 718 of each of the plurality of structures 716 and the base portion 742 while retaining the activity of the catalyst layer 728 on the at least one side surface 720, 722 of each of the plurality of structures 716. The selective passivation process is a plasma enhanced chemical vapor deposition process. At step 1708, the second metallic layer 730 is formed on the at least one side surface 720, 722 of each of the plurality of structures 716. The second metallic layer 730 is generated by electroless metal growth due to a reaction between the catalyst layer 728 and one or more reagents. Further, in an embodiment, the second metallic layer 730 is darkened. In an example, the second metallic layer 730 is darkened by anodization. In another example, the absorption layer 732 is formed on the second metallic layer 730 by micro-etching More particularly, the second metallic layer 730 is darkened by micro-etching.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

### LIST OF ELEMENTS

100 Optical Film
102 Upper Major Surface
104 Lower Major Surface
106 Base Film
108 Substrate
110 First Surface
112 Second Surface
114 Louver Structure
116 Structures
118 Upper Surface
120 Side Surface
122 Side Surface
124 Channels
126 First Metallic Layer
128 Catalyst Layer
130 Second Metallic Layer
132 Absorption Layer
134 Liner
136 Material
140 Interface
142 Base Portion
700 Optical Film
706 Base Film
708 Substrate
710 First Surface
712 Second Surface
716 Structures
718 Upper Surface
720 Side Surface
722 Side Surface
724 Channels
726 First Metallic Layer
728 Catalyst Layer
730 Second Metallic Layer
732 Absorption Layer
734 Liner
736 Material
738 Passivated Layer
742 Base Portion
1100 Optical Film
1106 Base Film
1108 Substrate
1110 First Surface
1112 Second Surface
1114 Louver Structure
1116 Structures
1118 Upper Surface
1120 Side Surface
1124 Channels
1126 First Metallic Layer
1128 Catalyst Layer
1130 Second Metallic Layer
1132 Absorption Layer
1134 Liner
1136 Material
1142 Base Portion
1600 Method
1602 Step
1604 Step
1606 Step
1608 Step
1700 Method
1702 Step
1704 Step
1706 Step
1708 Step
L Land Region
N Normal Axis
θI Interface Angle
Φ1 Internal Viewing Cutoff Angle
W Base Width
H Height
P Pitch
θP Polar Viewing Cutoff Angle
θ1 Polar Viewing Cutoff Half Angle
θ2 Polar Viewing Cutoff Half Angle

1. A method of manufacturing an optical film, the method comprising:
providing a base film including:
a substrate defining a first surface and a second surface disposed opposite to the first surface; and
a plurality of structures extending from a base portion, wherein each of the plurality of structures defines an upper surface and at least one side surface extending from the corresponding upper surface to the base portion;
depositing a catalyst material on each of the plurality of structures and the base portion to form a catalyst layer thereon;
selectively removing the catalyst layer from the upper surface of each of the plurality of structures and the base portion while retaining an activity of the catalyst layer on the at least one side surface of each of the plurality of structures; and
forming a metallic layer on the at least one side surface of each of the plurality of structures, wherein the metallic layer is generated by electroless metal growth due to a reaction between the catalyst layer and one or more reagents.

2. The method of claim 1, wherein the optical film includes a plurality of channels formed between adjacent structures of the plurality of structures; and
wherein each of the plurality of channels is filled with a material similar to a material of the structures.

3. (canceled)

4. The method of claim 1, wherein a cross-section of each of the plurality of structures includes at least one of a square shape, a circular shape, a trapezoidal shape, and a polygonal shape.

5. The method of claim 1 further comprising darkening the metallic layer.

6. The method of claim 1 further comprising providing an absorption layer on the metallic layer by micro-etching.

7. The method of claim 1, wherein the base film is formed by micro-replication.

8. The method of claim 1, wherein the catalyst material includes at least one of nickel, copper, cobalt, silver, gold, iridium, ruthenium, platinum, and palladium.

9. The method of claim 1, wherein the catalyst layer is selectively removed by a reactive-ion etching process or a sputter etching process.

10. The method of claim 1 further comprising providing a liner on the second surface of the substrate and removing the liner from the second surface after the formation of the metallic layer.

11. (canceled)

12. A method of manufacturing an optical film, the method comprising:
providing a base film including:
a substrate defining a first surface and a second surface disposed opposite to the first surface; and
a plurality of structures extending from a base portion, wherein each of the plurality of structures defines an upper surface and at least one side surface extending from the corresponding upper surface to the base portion;
depositing a catalyst layer on each of the plurality of structures and the base portion;
selectively passivating the catalyst layer on the upper surface of each of the plurality of structures and the base portion while retaining an activity of the catalyst layer on the at least one side surface of each of the plurality of structures; and
forming a metallic layer on the at least one side surface of each of the plurality of structures, wherein the metallic layer is generated by electroless metal growth due to a reaction between the catalyst layer and one or more reagents.

13. The method of claim 12, wherein the optical film includes a plurality of channels formed between adjacent structures of the plurality of structures; and
wherein each of the plurality of channels is filled with a material similar to a material of the structures.

14. (canceled)

15. The method of claim 12 further comprising darkening the metallic layer.

16. The method of claim 12 further comprising providing an absorption layer on the metallic layer by micro-etching.

17. The method of claim 12, wherein the base film is formed by micro-replication.

18. The method of claim 12, wherein the catalyst material includes at least one of nickel, copper, cobalt, silver, gold, iridium, ruthenium, platinum, and palladium.

19. (canceled)

20. An optical film comprising:
a base film including:
a substrate defining a first surface and a second surface disposed opposite to the first surface; and
a plurality of structures extending from a base portion, wherein each of the plurality of structures defines an upper surface and at least one side surface extending from the corresponding upper surface to the base portion;
a discontinuous first metallic layer disposed on the at least one side surface of the plurality of structures; and
a second metallic layer disposed on the first metallic layer on the at least one side surface of each of the plurality of structures.

21. The optical film of claim 20, wherein the optical film includes a plurality of channels formed between adjacent structures of the plurality of structures; and
wherein each of the plurality of channels is filled with a material similar to a material of the structures.

22. (canceled)

23. The optical film of claim 20, wherein the first metallic layer includes at least one of nickel, copper, cobalt, silver, gold, iridium, ruthenium, platinum, and palladium.

24. The optical film of claim 20, wherein the second metallic layer is darkened.

25. The optical film of claim 20, wherein an absorption layer is formed on the second metallic layer by micro-etching.
